(19) United States
(12) Patent Application Publication
(10) Pub. No.: US 2014/0210880 A1
(43) Pub. Date: Jul. 31, 2014

(54) UNIFORM OUTPUT OF LIGHT-EMITTING DIODE ARRAY

(71) Applicant: HEWLETT-PACKARD INDUSTRIAL PRINTING LTD., Netanya (IL)

(72) Inventors: Yochai EDLITZ, Netanya (IL); Ran Vilk, Ono (IL); Alexander Markman, Tel Aviv (IL)

(73) Assignee: Hewlett-Packard Industrial Printing Ltd., Netanya (IL)

(21) Appl. No.: 13/756,175

(22) Filed: Jan. 31, 2013

(51) Int. Cl. H05B 37/02

(52) U.S. Cl. CPC H05B 37/02
USPC 347/5; 315/151

(57) ABSTRACT

Examples are provided of plural light-emitting diodes (LEDs) arranged as vectors within an array. The vectors are individually drivable by way of a controller. A sensor scans the array and individual energy output values are correlated to electrical drive currents for each vector. The correlated data is recorded and used to control the vectors such that an equalized or uniform photonic energy profile is incident upon a media positioned as a target with respect to the LED system.

### BACKGROUND

Ink-jetting printers form images on media using one or more colors of liquid ink. Some inks require treatment to affix or cure them on the media. The present teachings address the foregoing and related concerns.

### BRIEF DESCRIPTION OF THE DRAWINGS

The present embodiments will now be described, by way of example, with reference to the accompanying drawings, in which:

FIG. 1 depicts a schematic diagram and equivalency diagram of an array of light-emitting diodes (LEDs) according to one example of the present teachings;

FIG. 2 depicts a plan diagram of a module supporting an array of LEDs according to another examples of the present teachings;

FIG. 3 depicts a page-wide array (PWA) including plural modules according to an example of the present teachings;

FIG. 4 depicts an arrangement including a PWA according to another example;

FIG. 5 depicts a system in accordance with an example of the present teachings;

FIG. 6 depicts another system in accordance with an example of the present teachings;

FIG. 7 depicts flow diagram of method steps according to another example of the present teachings; and

FIG. 8 depicts another system including a computer and a printer in accord with the present teachings.

### DETAILED DESCRIPTION

### Introduction

Systems and methods are provided regarding plural light-emitting diodes (LEDs) arranged as vectors within an array. The vectors are individually drivable by way of a controller. A sensor is used to scan the array and to provide energy output values for each of the vectors. The energy output values are correlated to electrical drive currents for each of the vectors. The correlated data is recorded and used to control the vectors so that an equalized or uniform photonic energy profile is incident upon a media positioned as a target with respect to the LED system.

In one example, a system includes a plurality of light-emitting diodes (LEDs) arranged to define one or more vectors. The system also includes a sensor to be translated along a pathway proximate to the LEDs. The sensor is configured to provide signaling corresponding to an energy output from each of the vectors. The system also includes a computer to receive the signaling and to derive a data set correlating a photonic energy value with an electric drive current for each of the vectors. The system further includes a controller to use the data set to equalize photonic energy outputs from the LEDs incident upon a target.

In another example, a printing system includes a controller and a print engine. The print engine is configured to form images on media by way of ink-jetting, and the print engine is controlled by the controller. The printing system also includes a plurality of light-emitting diodes (LEDs) arranged as a page-wide array. The LEDs are electrically coupled to each other such that one or more individually controllable vectors are defined. The LEDs are configured to emit photonic energy to cure ink on the media. The printing system also includes a sensor to be translated relative to the page-wide array. The sensor is configured to provide signals corresponding to a photonic energy from each the vectors. The printing system further includes a computer to derive a data set from the signals. The controller is further configured to use the data set to control each of the vectors.

### Illustrative Light-Emitting Diode Circuits

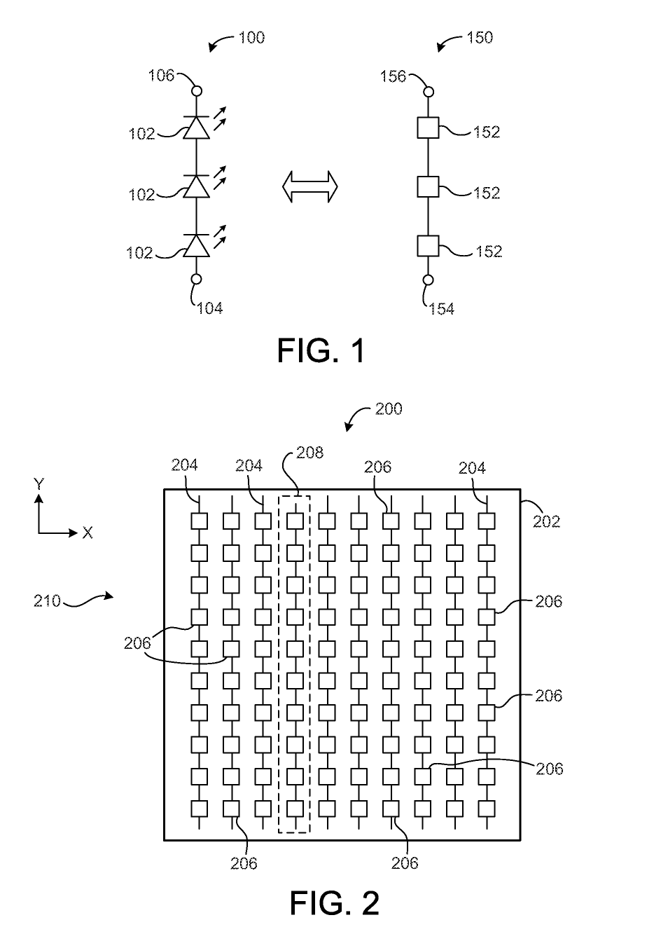

Attention is directed now to FIG. 1, which depicts a schematic diagram 100 of a circuit (or vector) of light-emitting diodes (LEDs), and an equivalent diagram 150 in accordance with the present teachings. The diagram 150 provides a simplified depiction of the circuitry of the schematic diagram 100. The respective diagrams 100 and 150 are illustrative and non-limiting with respect to the present teachings. Other circuits, constituencies or configurations can also be used.

The diagram 100 includes three LEDs 102 coupled (or connected) in series-circuit arrangement. The diagram 100 also includes (or is defined by) a node 104 and a node 106. The LEDs 102 can be activated (i.e., illuminated, or driven) by way of a (conventional) electrical current flow there through, from the node 104 to the node 106. In one example, each of the LEDs 102 has a forward voltage drop of about 4.0 VDC, for a total series voltage drop of about 12.0 VDC.

The diagram 150 includes three respective LEDs 152, each being electrically equivalent to an LED 102. The diagram 150 also includes (or is defined by) a node 154 and a node 156. The LEDs 152 can be activated (by way of an electrical current flow there through, from the node 154 to the node 156. In this way, entire series circuits, or vectors, of LEDs are operable by way of providing electrical energy to the corresponding nodes 102 and 104, or 152 and 154, respectively.

The schematic diagram 100 depicts a vector of LEDs, while the diagram 150 depicts an electrically equivalent construct of simplified graphical presentation. Three LEDs are depicted in each of the diagrams 100 and 150 in the interest of clarity. However, the present teachings contemplate vectors or “strings” each arranged as a linear row, folded back to define two or more parallel rows, arranged as rows as various angles, and so on. Other suitable arrangement geometries or series circuits inclusive of any suitable number of LEDs (six, ten, fourteen, and so on) can also be used. In one example, the LEDs (e.g., 102, 152) emit photonic energy in the ultraviolet (UV) region of the electromagnetic spectrum. Other suitable LEDs can also be used.

### Illustrative Module

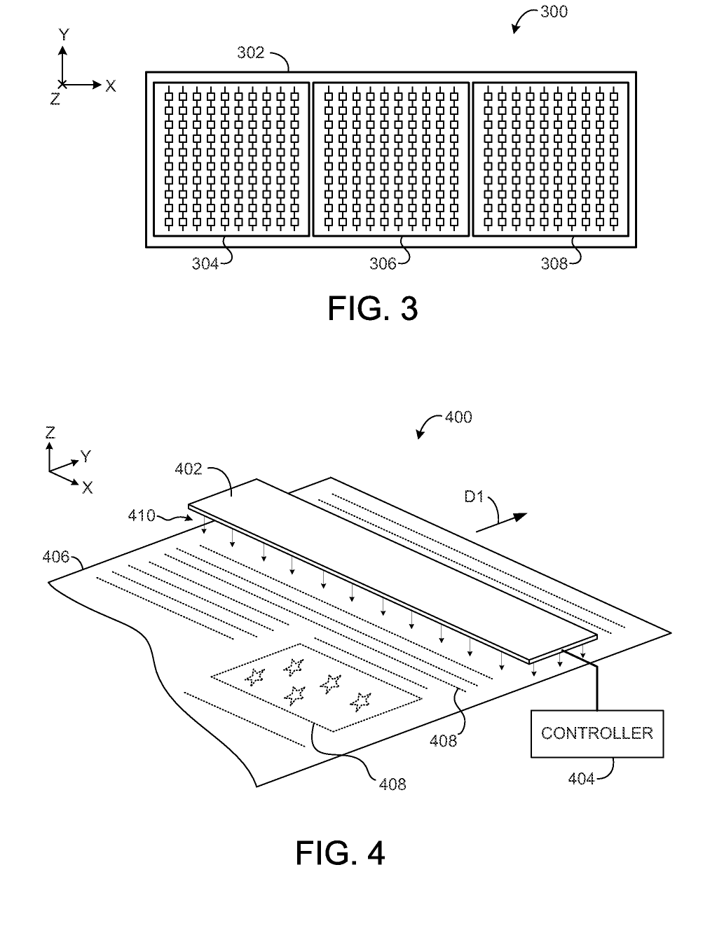

Reference is made now to FIG. 2, which depicts a plan diagram of a module 200 in accordance with the present teachings. The module 200 is illustrative and non-limiting, and other modules of respectively varying constituency, LED array size, or other parameters can also be used according to the present teachings.

The module 200 includes a substrate 202. In one example, the substrate 202 is formed from or includes silicon. Other suitable materials can also be used. The module 200 also includes ten electrically conductive pathways 204 defining ten respective columns. Each of the pathways 204 can be formed upon and supported by the substrate 202. The pathways 204 can be formed from or include aluminum, copper, or another suitable, electrically conductive material.

The module 200 also includes one-hundred LEDs 206 formed and supported on the substrate 202. Each of the LEDs 206 is electrically coupled in series-circuit relationship within nine other LEDs 206 within one of the respective column pathways 204 such that ten circuits (or vectors) 208 are defined. In turn, each vector 208 can be individually activated (energized) by way of electrical current flow through the corresponding pathway 204.

Additionally, the LEDs 206 of the respective circuits 208 are spaced apart from each with equal distance or “pitch” in two orthogonal axes “X” and “Y” such that a square array (or matrix) 210 is defined. In one example, the LEDs are separated by a pitch of 3.0 millimeters in both axes. Other suitable dimensions can also be used. In one example, each of the LEDs 206 is defined by a UV emitting LED. Other suitable LEDs can also be used. The illustrative module 200 includes one-hundred LEDs 206 arranged in ten columns (i.e., 10×10). However, other arrays having respectively varying LED counts or arranged in other configurations can also be used.

### Illustrative Page-Wide Array

Attention is directed to AG. 3, which depicts a diagrammatic view of a page-wide array (PWA) 300 according to the present teachings. The PWA 300 is illustrative and non-limiting in nature, and other PWA or array configurations can also be used in accordance with the present teachings.

The PWA 300 includes a substrate 302. In one example, the substrate 302 is formed from or includes silicon. Other suitable materials can also be used. The PWA 300 also includes a first module 304, a second module 306, and a third module 308. Each module 304-308 includes an array (e.g., 210) of LEDs (e.g., 206) that are addressable as respective vectors (e.g., 208) by way of suitable control circuitry. In one example, each module 304-308 is defined by a 10×10 array of UV LEDs. Other PWAs having varying module counts or respective module (array) sizes can also be used.

The PWA 300 is characterized by a generally flattened form-factor, with a thickness dimension extending in the “Z” axis (into the page) as depicted. The respective LEDs of each module 304-308 are disposed so as to emit photonic energy normal to the plane of the substrate 302. The PWA 300 is further configured to be electrically coupled to suitable control circuitry for individually driving each of the respective LED vectors (or series-circuits).

### Illustrative Arrangement

Attention is turned now to FIG. 4, which depicts an arrangement 400 according to a non-limiting example of the present teachings. The arrangement 400 is illustrative in nature, and other varying arrangements are also contemplated by the present teachings.

The arrangement 400 includes a PWA 402. The PWA 402 includes one or more modules (e.g., 200) each having a respective array (e.g., 210) of UV-emitting LEDs (e.g., 208). The PWA 402 is oriented such that photonic (radiant) energy from the LEDs is directed downward as depicted (“−Z” direction). The arrangement includes a controller 404 to individually drive the LEDs of the PWA 402 during typical, normal operations. The controller 404 can be variously defined as, for example, discussed hereinafter. The controller 404 is electrically coupled to the PWA 402.

The arrangement 400 further includes a sheet media 406 having images formed thereon in ink media 408. Such images can include text, graphics, photographic images, indicia and the like, or any suitable combination thereof. In one example, the ink media 408 forms images corresponding to an illustrated technical writing. Other examples can also be used.

The sheet media 406 is transported relative to the PWA 402 as indicated by the directional arrow “D1”. Specific means for transporting the sheet media 406 are not germane to the present teachings, and any suitable mechanism or technique can be used. Contemporaneously, ultraviolet photonic energy 410 is emitted from the PWA 402 so as to cure (i.e., affix or dry) the ink media 408 on the sheet media 406. The respective vectors of LEDs are individually operated by the controller 404 such that a uniform (or equalized) energy output is incident upon the sheet media 406, resulting in a uniform curing of the ink media 408 there on.

### First Illustrative System

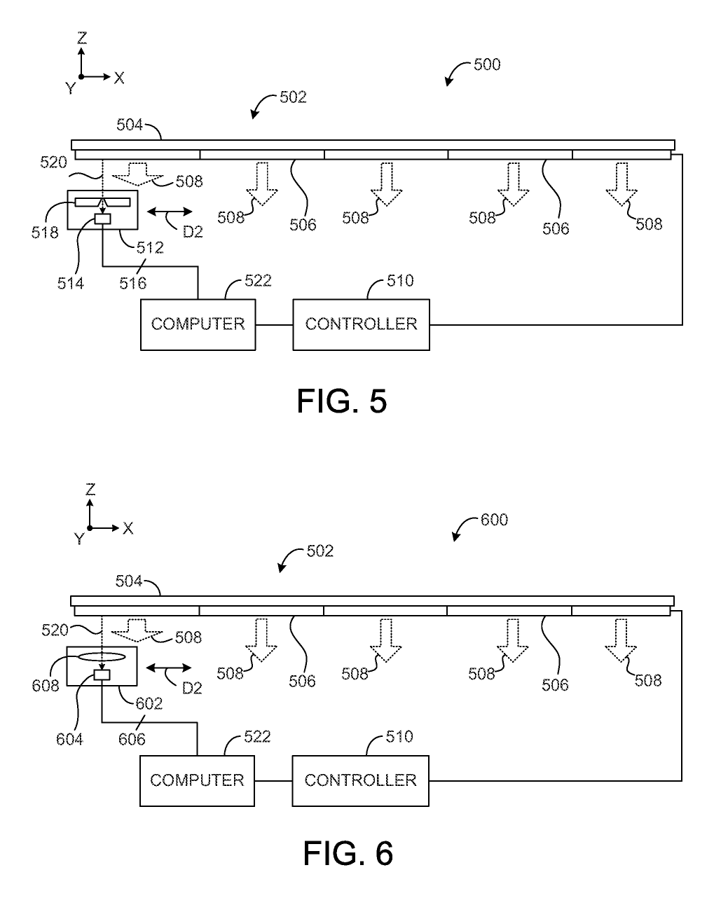

Reference is now made to FIG. 5, which depicts a system 500 in accordance with the present teachings. The system 500 is illustrative and non-limiting, and other respectively varying systems can also be used.

The system 500 includes a PWA 502 including a substrate 504 and five respective modules 506 supported thereon. Each of the modules 506 includes an array (e.g., 210) of UV-emitting LEDs (e.g., 206). The LEDs within each module 506 are addressable as series strings or vectors (e.g., 208) so that the emission of UV energy 508 can be controlled across the PWA 502 during normal operations. The system 500 also includes a controller 510 configured and coupled to the PWA 502 so as to individually operate the respective vector. In one example, the PWA 502 is analogous to the PWA 300 described above.

The system 500 further includes a scanner 512. The scanner 512 is configured to be bidirectionally translated relative to the PWA 502 as depicted by the arrow “D2”. That is, the scanner 512 can be controllably translated at least parallel to the lengthwise (“X” axis) aspect of the PWA 502. Other suitable motions of the scanner 512 can also be used.

The scanner 512 includes a sensor 514 configured to detect photonic energy from all of the LEDs of a particular vector of the PWA 502 contemporaneously. The sensor 514 is also configured to provide electronic signaling 516 corresponding to the collective photonic energy output level of the vector presently being sensed. In one non-limiting example, the sensor 514 is defined by or includes a charge-coupled device (COD) configured to detect emissions from, and provide signaling corresponding to, ten LEDs collectively arranged as a vector. Other constituencies or configurations can also be used. Typically, but not necessarily, the sensor 514 is configured to detect emissions from one entire vector of LEDs in accordance with a widthwise (“Y” axis) aspect of the PWA 502, and to provide corresponding signal 516 content.

The scanner 512 also includes an optical slit 518. The optical slit 518 passes a relatively narrow beam or ribbon of photonic energy 520 onto the sensor 514. Thus, the optical slit 518 performs a limiting or collimating function with respect to the photonic emissions of the LEDs of the PWA 502. The optical slit 518 is of known (selected) aperture dimensions such that instantaneous photonic intensity can be correlated to total radiant energy output. Additionally, peak radiant energy output from each vector of LEDs can be sensed (and measured) by synchronizing sampling of the signaling 516 with the instantaneous location of the scanner 512 relative to the PWA 502.

The system 500 also includes a computer 522. The computer 522 can be variously defined and is inclusive of a processor operating in accordance with a machine-readable program code. In one example, the computer 522 is a desktop personal computer (PC) operating in accord with “software” programming. In another example, the computer 522 is defined by a microprocessor or microcontroller embedded within an apparatus. The computer 522 is coupled to receive the signaling 516 from the sensor 514.

The computer 522 is configured, by virtue of program code, to process the signaling 516 content and to correlate a photonic energy value with the corresponding electrical drive current for each vector of the PWA 502. The computer 522 is also configured to derive a data set or “lookup table” corresponding to (or inclusive of) the correlated data that is communicated to the controller 510. In turn, the controller 510 is configured to use the data set or lookup table in order to equalize or “level out” the respective photonic emissions incident upon a target (e.g., sheet media, and so on) proximate to the PWA 502.

The sensing and signaling operations performed by the scanner 512 can be performed periodically, in response to a number of sheet media (e.g., 406) operated upon by the PWA 502, and so on, in accord with any number of operating stratagems. The scanner 512 can be translated to a waiting location and maintained there so as to not interfere with normal PWA 502 operations, until such time as another sensing (i.e., calibration) operation is called for. In one or more examples, the computer 522 and the controller 510 are integrated or defined by a single entity.

### Second Illustrative System

Attention is directed to FIG. 6, which depicts a system 600 in accordance with the present teachings. The system 600 is illustrative and non-limiting, and other respectively varying systems can also be used.

The system 600 includes the PWA 502, the controller 510 and the computer 522 as respectively described above. The system 600 further includes a scanner 602. The scanner 602 is configured to be bidirectionally translated relative to the PWA 502 at least as depicted by the arrow “D2”. Other suitable motions of the scanner 602 can also be used.

The scanner 602 includes a sensor 604 configured to detect photonic energy from all of the LEDs of a particular vector of the PWA 502. The sensor 604 is also configured to provide electronic signaling 606 corresponding to the sensed collective photonic energy output level. In one non-limiting example, the sensor 604 includes a charge-coupled device (COD) configured to sense ten respective LEDs within a vector simultaneously. Other constituencies or configurations can also be used.

The scanner 602 also includes an optical lens 608. The optical lens 608 functions to pass a relatively narrow beam or ribbon of photonic energy 520 onto the sensor 604. Thus, the optical lens 608 performs a limiting or collimating (i.e., focusing) function with respect to the photonic outputs of the LEDs of the PWA 502. The optical lens 608 is of selected optical characteristics such that instantaneous photonic intensity can be correlated to total radiant energy output, or peak radiant energy from each vector of LEDs can be determined generally as described above.

The computer 522 operates as described above, deriving correlated energy level/current drive data (or a lookup table) that is communicated to the controller 510. The controller 510 uses the data set or lookup table to control the respective photonic emissions of each vector of LEDs such that uniform energy emissions from the PWA 502 are incident upon a target. The scanner 602 can be kept or “parked” out of cooperative orientation with the PWA 502 during normal operations.

### Illustrative Method

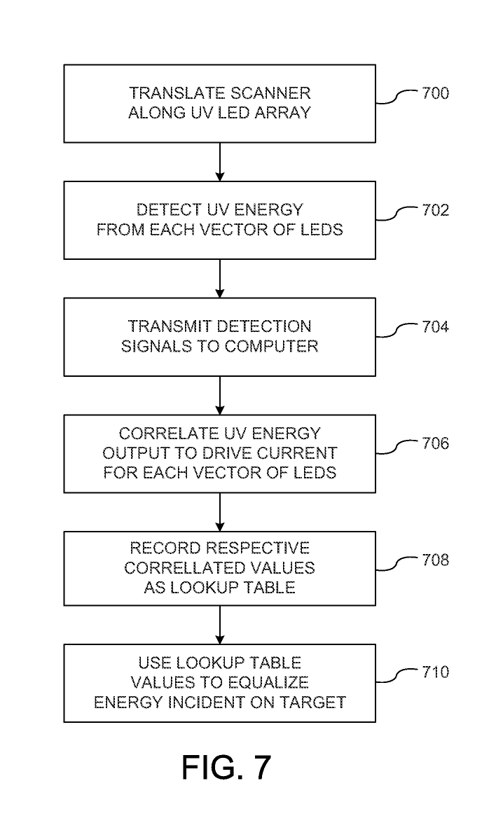

Reference is made now to FIG. 7, which depicts a flow diagram of a method according to the present teachings. The method of FIG. 7 includes particular steps performed in a particular order of execution. However, other methods including other steps, omitting one or more of the depicted steps, or proceeding in other orders of execution can also be defined and used. Thus, the method of FIG. 7 is illustrative and non-limiting with respect to the present teachings. Reference is also made to FIG. 5 in the interest of illustrating the method of FIG. 7.

At 700, a scanner is translated along a UV LED array. For purposes of illustrative example, the scanner 512 is translated parallel to and in spaced adjacency with the page-wide array 502. Thus, the scanner 512 is moved along in the “X” direction so as to progressively “scan” the entire photon emitting constituency of the PWA 502.

At 702, UV energy is detected from each vector of LEDs. In the present example, photonic energy 520 in the UV region of the spectrum passes through the optical slit 518 and is incident upon the sensor 514. The sensor 514 is configured to detect (i.e., sense) the photonic emissions of an entire vector (or series) of LEDs simultaneously and to provide corresponding electronic signaling.

At 704, detection signals are transmitted to a computer. In the present example, electronic signals 516 are transmitted from the sensor 514 to the computer 522. The signaling 516 includes digital data or other electrically encoded content correspondent to the LED vector emission intensities incident upon the sensor 514. Thus, the computer 522 receives information corresponding to photonic energy output level for each vector of LEDs in the PWA 502.

At 706, the UV energy output is correlated to the drive current for each vector. In the present example, the computer 522 processes the signaling 516 so as to determine (i.e., quantify, or measure) a photonic energy output value (e.g., milliwatts) for each vector of LEDs and correlates that value with a respective electrical drive current (e.g., milliamperes). A data set is thus derived including a correlated pair of output power and drive current values for each vector in the PWA 502.

At 708, the respective correlated values are recorded as a lookup table. In the present example, the correlated value (data set) is formatted as a lookup table and communicated from the computer 522 to the controller 510. The controller 510 stores the lookup table (data set) for later use. Other salient information can also be recorded in or with the lookup table, such as location information for each vector, a timestamp for the derivation of the lookup table, and so on.

At 710, the lookup table values are used to equalize energy outputs incident upon a target. In the present example, the controller 510 accesses the lookup table and provides respective drive currents to each vector of LEDs in the PWA 502 during a normal (e.g., ink curing) operation. In particular, the controller 510 adjusts or selects the magnitude or time duration (e.g., pulse) of each respective drive current in accordance with the lookup table resulting in uniform photonic energy emissions incident upon a target. Such a target, for non-limiting example, can be a sheet media bearing UV-curable (or fixable) ink.

### Third Illustrative System

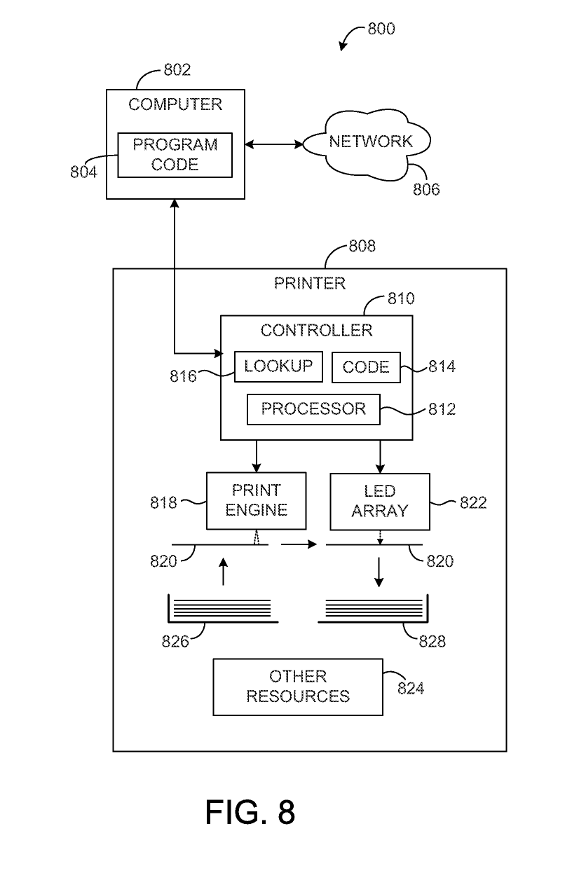

Attention is now turned to FIG. 8, which depicts a system 800 in accordance with another example of the present teachings. The system 800 is illustrative and non-limiting, and other systems, apparatus, devices and configurations can also be used.

The system 800 includes a computer 802. The computer 802 can be variously defined and in one example, is a general-purpose desktop computer operating in accordance with a machine-readable program code 804. The program code 804 is stored on tangible, machine-accessible media such as a non-volatile memory, an optical disk, a magnetic disk, and so on. The computer 802 is connected for bidirectional communication with a network 806. In one example, the network 806 includes connection to the Internet. Other network structures can also be used.

The system 800 also includes a printer 808. The printer 808 includes a controller 810 configured to control numerous normal operations of the printer 808. The controller 810 can be variously defined or inclusive of any suitable electronic circuitry. As depicted, the controller is at least partially defined by a processor 812 configured to operate according to a machine-readable program code 814. In turn, the program code 814 is stored on suitable, machine-accessible tangible media. The controller 810 further includes a lookup table 816 having correlated output-energy/drive-current data for operating a page-wide array of LEDs.

The printer 808 also includes a print engine 818 configured to form images on sheet media 820 using ink or another liquid media. The print engine 818 can be variously defined and operation thereof is controlled by signaling from the controller 810. In one illustrative example, the print engine 818 is defined by a page-wide ink-jetting array configured to form images in one or more respective colors. Other suitable print engines can also be used.

The printer 808 also includes an LED array 822. The LED array 822 is controlled by the controller 810 and includes some number of UV-emitting LEDs (e.g., 208). In one illustrative example, the LED array 822 is defined by a PWA (e.g., 402) including one or more modules (e.g., 304), each module including a plurality of (e.g., ten) addressable vectors of UV-emitting LEDs. Other suitable LED arrays can also be used.

The printer 808 also includes other resources 824. Such other resources 824 can include any suitable elements, sub-systems and the like to perform respective functions. Non-limiting examples of other resources 824 include a display screen, an operator interface, wireless communications circuitry, a memory media interface, sheet media transport mechanisms, a power supply, and so on.

Typical, normal operations of the system 800 are illustrated as follows: a user of the computer 802 retrieves an electronic document file from the network 806. Such a file could be, for example, a document produced by way of a word processing application. The user provides input to the computer 802 so as to cause printing of the document on paper media. The computer 802 communicates corresponding data to the controller 810 of the printer 808 by way of electronic signaling.

The controller 810 provides respective control signals to the print engine 818, the LED array 822 and other resources 824, as needed, to effect printing of the document. In particular, sheet media is drawn one sheet at a time from a supply tray 826. Images in ink media are formed on the respective sheets, resulting in printed sheet media 820, which are then transported into operative proximity to the LED array 822.

The LED array 822 generates UV photonic energy that is incident to the printed side of the sheet media 820. The ink media thereon is cured or affixed (or both) to the printed sheet media 820, which are then accumulated in a receiving tray 828. The printing operation is completed when all requisite sheet media have been imaged and cured, accordingly.

During the printing and curing operation, the controller 810 individually drives vectors of the LED array 822 using the lookup table 816 data to determine the respective drive currents. A uniform (or equalized) energy output profile is thus incident upon the printed sheet media 820, resulting in uniform curing or fixing (or both) of the ink media there on.

In general, the present teachings contemplate systems, electronic circuits, apparatus and methods for controlling operation of an array of LEDs. Typically, but not necessarily, such LEDs emit photonic energy (i.e., light) in the ultraviolet region of the spectrum. A scanner including a photonic energy sensor is used to scan such an array and provide signals corresponding to respective energy output levels from defined vectors (or series-circuits) of LEDs. The signals are provides to a computer or other suitable entity for processing.

The photonic output level (or intensity) for each vector is correlated to a corresponding electrical drive current such that a data set is derived for the LED array. The data set can be used to define a lookup table or other suitable construct that is stored for use by the LED array controller. The controller can then use the lookup table (i.e., correlated data set) to individually drive the vectors of the array such that uniform photonic energy is incident upon a target. Other suitable, non-uniform energy output profiles can also be generated accordingly. Uniform curing, fixing, and so on, of liquid inks or other substances is thus performed in accordance with the array control signaling.

In general, the foregoing description is intended to be illustrative and not restrictive. Many embodiments and applications other than the examples provided would be apparent to those of skill in the art upon reading the above description. The scope of the invention should be determined, not with reference to the above description, but should instead be determined with reference to the appended claims, along with the full scope of equivalents to which such claims are entitled. It is anticipated and intended that future developments will occur in the arts discussed herein, and that the disclosed systems and methods will be incorporated into such future embodiments. In sum, it should be understood that the invention is capable of modification and variation and is limited only by the following claims.

What is claimed is:

1. A system, comprising:
a plurality of light-emitting diodes (LEDs) arranged to define one or more vectors;
a sensor to be translated along a pathway proximate to the LEDs, the sensor to provide signaling corresponding to an energy output from each of the vectors;
a computer to receive the signaling and to derive a data set correlating a photonic energy value with an electric drive current for each of the vectors; and
a controller to use the data set to equalize photonic energy outputs from the LEDs incident upon a target.

2. The system according to claim 1 further comprising an optical slit to pass photonic energy from one of the vectors onto the sensor.

3. The system according to claim 1 further comprising a lens to focus photonic energy from one of the vectors onto the sensor.

4. The system according to claim 1 further comprising a print engine to form images on media by way of ink-jetting, the LEDs to emit photonic energy so as to cure ink on the media.

5. The system according to claim 1, one or more of the LEDs to emit ultraviolet photonic energy.

6. The system according to claim 1, the vectors arranged to define one or more modules.

7. The system according to claim 6, the one or more modules arranged to define a page-wide array.

8. The system according to claim 6, the LEDs within each module disposed in spaced adjacency to each other so as to define a rectangular or square array.

9. The system according to claim 1, the LEDs within each of the vectors coupled to each other in series-circuit relationship.

10. The system according to claim 1, the vectors being individually operable by the controller.

11. A printing system, comprising:
a controller;
a print engine to form images on media by way of ink-jetting, the print engine controlled by the controller;
a plurality of light-emitting diodes (LEDs) arranged as a page-wide array, the LEDs electrically coupled to each other such that one or more individually controllable vectors are defined, the LEDs to emit photonic energy to cure ink on the media;
a sensor to be translated relative to the page-wide array, the sensor to provide signals corresponding to a photonic energy from each the vectors; and
a computer to derive a data set from the signals, the controller to use the data set to control each of the vectors.

12. The printing system according to claim 11, the computer such that the data set correlates a photonic energy value with an electrical drive current for each of the vectors.

13. The printing system according to claim 11, at least some of the LEDs being ultraviolet (UV) emitting LEDs.

14. The printing system according to claim 11, the vectors provided as one or more modules, the LEDs within each respective module arranged as rectangular or square array.

15. The printing system according to cam the sensor to be translated so as to provide signals corresponding to each and every one of the vectors of the page-wide array.
